(19) United States
(12) Patent Application Publication
(10) Pub. No.: US 2024/0166563 A1
(43) Pub. Date: May 23, 2024

(54) MORTAR MIX AND CONCRETE MIX INCORPORATING A STILLAGE LIQUID

(71) Applicant: University of Kentucky Research Foundation, Lexington, KY (US)

(72) Inventors: Robert Benjamin Jewell, Lexington, KY (US); Anne Elizabeth Oberlink, Lexington, KY (US); Rodney Andrews, Lexington, KY (US)

(21) Appl. No.: 18/282,788

(22) PCT Filed: Mar. 21, 2022
(86) PCT No.: PCT/US22/21112

§ 371 Date: Sep. 19, 2023

Related U.S. Application Data
(60) Provisional application No. 63/163,294, filed on Mar. 19, 2021.
(60) Provisional application No. 63/284,496, filed on Nov. 30, 2021.

(51) Int. Cl. C04B 18/10; C04B 14/06; C04B 28/04; C04B 111/00

(52) U.S. Cl. CPC C04B 18/103; C04B 14/06; C04B 28/04; C04B 2111/00767

(57) ABSTRACT

A mortar mix and a concrete mix incorporate a stillage admixture that improves the workability of fresh concrete and advantageously modifies the properties of the hardened concrete.

### RELATED APPLICATION

This application claims the benefit of U.S. Provisional Patent Application Ser. No. 63/163,294, filed on Mar. 19, 2021, and U.S. Provisional Patent Application Ser. No. 63/284,496, filed on Nov. 30, 2021, both of which are hereby incorporated by reference in their entirety.

### TECHNICAL FIELD

This document relates generally to the use of stillage liquid as an admixture in mortar and concrete in order to improve the workability of fresh concrete and to modify the properties of the hardened mortar or concrete.

### BACKGROUND

Stillage is the liquid waste that remains after ethanol distillation. The distillery industry, including, more particularly, the bourbon distillery industry, produces a very significant amount of stillage each year thereby creating a waste disposal concern.

As set forth in this document, it has now been discovered that the stillage liquid may be used as a “green” admixture in mortar and concrete. The substitution of the stillage liquid for some or all of the water normally used in mortar and concrete allows for a reduction in the total volume of water used in the mortar or concrete which, in turn, imparts a number of benefits and advantages including, but not necessarily limited to increased strength performance and improved concrete rheology. Further, this new use of the stillage liquid also eliminates the need to dispose of what would otherwise be a waste product of the distillery industry.

### SUMMARY

In accordance with the purposes and benefits described herein, a new and improved mortar mix is provided. That mortar mix comprises: cement, sand, water and a stillage liquid. The stillage liquid may be a processed stillage liquid. In at least one possible embodiment, the stillage liquid is a filtered stillage liquid without solids. In at least one possible embodiment, the stillage liquid has been subjected to a hydrothermal carbonization process prior to use in the mortar mix. In at least one possible embodiment, the stillage liquid is a bourbon stillage liquid.

In accordance with yet another aspect, the mortar mix may include: (a) about 23.6-24.8 weight percent cement, (b) about 65.0-68.3 weight percent sand, (c) about 6.6-9.1 weight percent water and (d) about 0.3 to about 2.3 weight percent stillage liquid. In some embodiments, all of the water is replaced by stillage liquid.

In one or more of the many possible embodiments of the mortar mix, the ratio of the volume of water to the volume of stillage liquid is between about 4 to 1 and about 19 to 1.

In accordance with yet another aspect, a new and improved concrete mix, comprises: cement, sand, aggregate, water and a stillage liquid. The stillage liquid may be a processed stillage liquid. In at least one possible embodiment, the stillage liquid is a filtered stillage liquid without solids. In at least one possible embodiment, the stillage liquid has been subjected to a hydrothermal carbonization process prior to use in the mortar mix. In at least one possible embodiment, the stillage liquid is a bourbon stillage liquid.

The concrete mix may include: (a) about 13.84-19.02 weight percent cement, (b) about 32.57-37.05 weight percent sand, (c) about 39.28-44.38 weight percent aggregate, (d) about 6.71-4.09 weight percent water and (e) about 2.41-0.34 weight percent stillage liquid. In some embodiments, all of the water is replaced with stillage liquid.

In one or more of the many possible embodiments of the concrete mix, the ratio of the volume of water to the volume of stillage liquid is between about 3.3 to 1 and about 15.9 to 1.

In accordance with yet another aspect, a mortar mix is provided including a stillage liquid. In at least one possible embodiment, the stillage liquid is a filtered stillage liquid without solids. In at least one possible embodiment, the stillage liquid has been subjected to a hydrothermal carbonization process prior to use in the mortar mix. In at least one possible embodiment, the stillage liquid is a bourbon stillage liquid.

In accordance with still another aspect, a concrete mix is provided including a stillage liquid. In at least one possible embodiment, the stillage liquid is a filtered stillage liquid without solids. In at least one possible embodiment, the stillage liquid has been subjected to a hydrothermal carbonization process prior to use in the mortar mix. In at least one possible embodiment, the stillage liquid is a bourbon stillage liquid

In addition, a method is provided for improving at least one performance characteristic of a mortar. That method comprises the step of adding a stillage liquid to the mortar as a substitute for at least some water in the mortar.

Still further, a method is provided for improving at least one performance characteristic of concrete. That method comprises the step of adding a stillage liquid to the concrete as a substitute for at least some water in the concrete.

A method is also provided for preparing a stillage admixture for mortar or concrete. That method comprises the step of filtering solids from a stillage liquid to provide the stillage admixture.

In another aspect, a method is provided for preparing a stillage admixture for mortar or concrete. That method comprises the step of subjecting a stillage liquid to hydrothermal carbonization processing to provide the stillage admixture.

A new method of preparing a stillage admixture for mortar or concrete, comprises filtering solids from a bourbon stillage liquid to provide the stillage admixture.

A new method of preparing a stillage admixture for mortar or concrete, comprises subjecting a bourbon stillage liquid to hydrothermal carbonization processing to provide the stillage admixture. This may include subjecting the bourbon stillage liquid to a temperature of about 250° C. and a pressure of about 1.379 N/mm² during hydrothermal carbonization processing.

In the following description, there are shown and described several preferred embodiments of the mortar mix, the concrete mix and the methods related thereto. As it should be realized, the mortar mix, the concrete mix and the methods are capable of other, different embodiments and their several details are capable of modification in various, obvious aspects all without departing from the mortar mix, the concrete mix and the methods as set forth and described in the following claims. Accordingly, the descriptions should be regarded as illustrative in nature and not as restrictive.

### BRIEF DESCRIPTION OF THE DRAWING FIGURES

The accompanying drawing FIGURES incorporated herein by reference and forming a part of the specification, illustrate several aspects of the mortar mix, the concrete mix and the methods related thereto and together with the description serve to explain certain principles thereof.

FIG. 1 is a mortar flow data graph plotting mortar flow against percent mixing water replaced by stillage liquid.

Reference will now be made in detail to the present preferred embodiments of the mortar mix, the concrete mix and the methods related thereto.

### DETAILED DESCRIPTION

A mortar mix may be generally described as a mixture of cement, sand, water and a stillage liquid. The cement may comprise Type-I Portland cement or substantially any other cement known in the art to be useful in mortar. The stillage liquid may be the liquid waste that remains after ethanol distillation. Such stillage is readily available from bourbon distilleries and is often referred to as bourbon stillage liquid.

The stillage liquid is preferably a processed stillage liquid. Processed stillage liquids include, but are not necessarily limited to, filtered stillage liquid without solids and stillage liquid that has been subjected to a hydrothermal carbonization process prior to use in the mortar mix.

The mortar mix may include about 23.6-24.8 weight percent cement, about 65.0-68.3 weight percent sand, about 6.6-9.1 weight percent water and about 0.3-2.3 weight percent stillage liquid. The ratio of the volume of water to the volume of stillage liquid is most commonly between about 4 to 1 to about 19 to 1. However, it should be appreciated that in some embodiments of the mortar mix for some applications, as much as all of the water may be replaced by stillage liquid.

A concrete mix may be generally described as a mixture of cement, sand, aggregate, water and a stillage liquid. The cement may comprise Type-I Portland cement or substantially any other cement known in the art to be useful in mortar. The aggregate may comprise gravel of a type and size known in the art to be useful in concrete. The stillage liquid may be the liquid waste that remains after ethanol distillation. Such stillage is readily available from bourbon distilleries and is often referred to as bourbon stillage liquid.

As with the mortar mix described above, the stillage liquid is preferably a processed stillage liquid. Processed stillage liquids include, but are not necessarily limited to, filtered stillage liquid without solids and stillage liquid that has been subjected to a hydrothermal carbonization process prior to use in the mortar mix.

The concrete mix may include about 13.84-19.02 weight percent cement, about 32.57-37.05 weight percent sand, about 39.28-44.38 weight percent aggregate, about 4.09-6.71 weight percent water and about 0.34-2.41 weight percent stillage liquid. The ratio of the volume of water to the volume of stillage liquid is most commonly between about 3.3 to 1 to about 15.9 to 1. However, it should be appreciated that in some embodiments of the concrete mix for some applications, as much as all of the water may be replaced by stillage liquid.

Advantageously, the mortar mix and concrete mix including stillage liquid are characterized by a number of benefits and advantages. Significantly, less water is required to provide the desired flow and workability to the mortar and the cement. The lower water/cement ratio imparts increased strength performance and improved concrete rheology.

Thus, it should be appreciated that a method of improving at least one performance characteristic of mortar includes the step of adding a stillage liquid to the mortar as a substitute for at least some of the water in the mortar. Similarly, a method of improving at least one performance characteristic of concrete, includes the step of adding a stillage liquid to the concrete as a substitute for at least some of the water in the concrete.

Related to the above is a method of preparing a stillage admixture for mortar or concrete, including the step of filtering solids from a stillage liquid to provide the stillage admixture. Also provided is a method of preparing a stillage admixture for mortar or concrete that includes the step of subjecting a stillage liquid to hydrothermal carbonization processing to provide the stillage admixture. Still further, a new method of preparing a stillage admixture for mortar or concrete includes the step of filtering solids from a bourbon stillage liquid to provide the stillage admixture.

In an alternative embodiment, a new method of preparing a stillage admixture for mortar or concrete includes the step of subjecting a bourbon stillage liquid to hydrothermal carbonization processing to provide the stillage admixture. The bourbon stillage liquid may be subjected to a temperature of about 250° C. and a pressure of about 1.379 N/mm² during the hydrothermal carbonization processing.

### EXPERIMENTAL

A. This experimental example describes the processing and utilizing of bourbon stillage as an admixture in concrete to modify the properties of hardened concrete or mortar and to improve the workability of fresh concrete.

The “as-received” stillage from the bourbon distillery contains both solids and liquid. The solids were filtered out of the stillage liquid in a manner known in the art. The stillage liquid was tested in place of the standard mixing water (tap water) and was tested as a percentage of the mixing water, i.e. 20% stillage liquid and 80% tap water.
Mortar Mix:
Type I Portland Cement—500.0 grams
ASTM Graded Sand—1375.0 grams
Deionized Water—168.8 grams
Stillage Water—42.2 grams

Below is the compressive strength performance improvement of mortar cubes prepared with stillage liquid as an admixture. In this example 20% of the mixing water was replaced with stillage liquid. Totaling 211 grams of mixing water. This allowed a reduction in total required mixing water from 242 grams to 211 grams a savings of 12.8%. This is important in that for concrete by reducing the water to cement ratio, yet retaining flow or workability of the mix, increased performance will result.
Sample ID Day 1 Day 7 Day 28
Control (Type-I Portland cement) no stillage 10.9 MPa 27.8 MPa 42.9 MPa
20%/80% Stillage Liquid to DI Water 11.3 MPa 34.3 MPa 47.5 MPa

Experimental data suggested that using bourbon stillage liquids in a cementitious system, as an admixture, can impart increased strength performance, provide water-reducing properties, improved concrete rheology, and the potential to delay strength development if high concentrations of stillage liquid is added (up to full replacement of standard, tap, mixing water).

The use of stillage liquid as an admixture as described has high impact potential on both the bourbon distillery industry and the ready-mixed concrete industry. This is accomplished by not only providing a solution for a growing concern on waste disposal from the bourbon industry but also provides a highly unique and “green” no chemical approach to concrete admixtures.

B. This experimental example describes the utilization of bourbon stillage after it has passed through a hydrothermal carbonization (HTC) process to produce a hydrochar. The byproduct liquid may be used as an admixture in concrete to modify the properties of hardened concrete or mortar and to improve the workability of fresh concrete.

The HTC processed bourbon stillage originated from a bourbon distillery and contained solids (grain and yeast) suspended in a liquid prior to the HTC process. Before hydrotreating the as-received stillage had a pH of 5-5.5 with a total dissolved carbon of 20,360 mg/Liter. The solids were processed out of the liquid by means of a hydrothermal carbonization process in which the stillage is subjected to 250° C. and a pressure of about 1.379 N/mm² (about 200 psi) (for a period of time to produce hydrochar from the plant material). The resulting byproduct is a stillage liquid “HTC Stillage” that after hydrotreating had a pH of 4.7 with a total dissolved carbon of 18,500 mg/Liter. The HTC Stillage was tested in place of standard mixing water (tap water) for cement hydration and was tested as a percentage of the mixing water, i.e. 20% stillage liquid and 80% tap water.
Mortar Mix:
Type I Portland Cement—500.0 grams
ASTM Graded Sand—1375.0 grams
Deionized Water—168.8 grams
HTC Stillage—42.2 grams

Below is the compressive strength performance of mortar cubes prepared with HTC stillage liquid as an admixture. In this example 20% of the mixing water was replaced with stillage liquid. Totaling 211 grams of mixing water. This allowed a reduction in total required mixing water from 242 grams to 211 grams a savings of 12.8%. This is important in that for concrete by reducing the water to cement ratio, yet retaining flow or workability of the mix, increased performance will result.
Sample ID Day 1 Day 7 Day 28
Control (Type-I Portland cement) no stillage 10.9 MPa 27.8 MPa 42.9 MPa
20%/80% HTC Stillage to DI Water 12.1 MPa 22.3 MPa 43.5 MPa

Experimental data suggested that using HTC bourbon stillage liquids in a cementitious system, as an admixture, can impart increased strength performance, provide water-reducing properties, improved concrete rheology, and the potential to delay strength development if high concentrations of stillage liquid is added (up to full replacement of standard, tap, mixing water).

The use of stillage liquid as an admixture as described has high impact potential on both the bourbon distillery industry and the ready-mixed concrete industry. This is accomplished by not only providing a solution for a growing concern on waste disposal from the bourbon industry but also provides a highly unique and “green” no chemical approach to concrete admixtures.

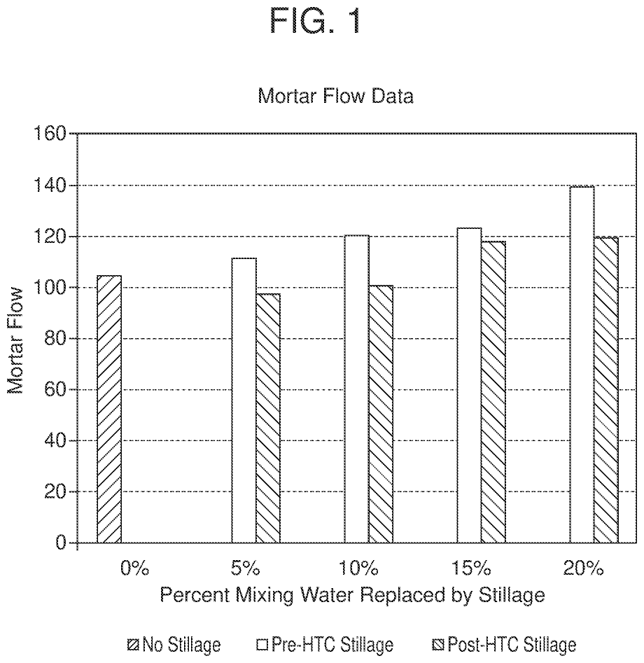

C. FIG. 1 illustrates the mortar flow results of mortar prepared with and without bourbon stillage, following ASTM procedures C305 and C1437. The chart indicates the mortar flow of a mortar prepared without stillage, indicated by the column at 0%. The chart also indicates the effect on mortar flow by the replacement of the mixing water with 5%, 10%, 15%, and 20% bourbon stillage. By replacing a percentage of the mixing water with bourbon stillage the mortar flow, or consistency of the mortar, increases. For example, by replacing 20% of the mixing water with bourbon stillage a 25.1% increase in mortar flow may be achieved. The Post-HTC processed stillage showed a 7.2% increase in mortar flow by replacing 20% of the mixing water.

This disclosure may be said to relate to the following items.

1. A mortar mix, comprising:
cement;
sand;
water; and
a stillage liquid.

2. The mortar mix of item 1, wherein the stillage liquid is a processed stillage liquid.

3. The mortar mix of item 1, wherein the stillage liquid is a filtered stillage liquid without solids.

4. The mortar mix of item 1, wherein the stillage liquid has been subjected to a hydrothermal carbonization process prior to use in the mortar mix.

5. The mortar mix of any of items 1-4, wherein the stillage liquid is a bourbon stillage liquid.

6. The mortar mix of item 5, including:
about 23.6-24.8 weight percent cement;
about 65.0-68.3 weight percent sand;
about 6.6-9.1 weight percent water; and
about 0.3-2.3 weight percent stillage liquid.

7. The mortar mix of item 6, wherein a ratio of a volume of the water to a volume of the stillage liquid is between about 4 to 1 and about 19 to 1.

8. The mortar mix of any of items 1-4, including:
about 23.6-24.8 weight percent cement;
about 65.0-68.3 weight percent sand;
about 6.6-9.1 weight percent water; and
about 0.3-2.3 weight percent stillage liquid.

9. The mortar mix of item 8, wherein a ratio of a volume of the water to a volume of the stillage liquid is between about 4 to 1 and about 19 to 1.

10. The mortar mix of any of items 1-4, wherein a ratio of a volume of the water to a volume of the stillage liquid is between about 4 to 1 and about 19 to 1.

11. A concrete mix, comprising:
cement;
sand;
aggregate;
water; and
a stillage liquid.

12. The concrete mix of item 11, wherein the stillage liquid is a processed stillage liquid.

13. The concrete mix of item 11, wherein the stillage liquid is a filtered stillage liquid without solids.

14. The concrete mix of item 11, wherein the stillage liquid has been subjected to a hydrothermal carbonization process prior to use in the mortar mix.

15. The concrete mix of any of items 11-14, wherein the stillage liquid is a bourbon stillage liquid.

16. The concrete mix of item 15, including:
about 13.84-19.02 weight percent cement;
about 32.57-37.05 weight percent sand;
about 39.28-44.38 weight percent aggregate;
about 4.09-6.71 weight percent water; and
about 0.34-2.41 weight percent stillage liquid.

17. The concrete mix of item 16, wherein a ratio of a volume of the water to a volume of the stillage liquid is between about 3.3 to 1 and about 15.9 to 1.

18. The concrete mix of any of items 11-14, including:
about 13.84-19.02 weight percent cement;
about 32.57-37.05 weight percent sand;
about 39.28-44.38 weight percent aggregate;
about 4.09-6.71 weight percent water; and
about 0.34-2.41 weight percent stillage liquid.

19. The concrete mix of item 18, wherein a ratio of a volume of the water to a volume of the stillage liquid is between about 3.3 to 1 and about 15.9 to 1.

20. The concrete mix of any of items 11-14, wherein a ratio of a volume of the water to a volume of the stillage liquid is between about 3.3 to 1 and 15.9 to 1.

21. A mortar mix, including a stillage liquid.

22. The mortar mix of item 21, wherein the stillage liquid is a processed stillage liquid.

23. The mortar mix of item 21, wherein the stillage liquid is a filtered stillage liquid without solids.

24. The mortar mix of item 21, wherein the stillage liquid has been subjected to a hydrothermal carbonization process prior to use in the mortar mix.

25. The mortar mix of any of items 21-24, wherein the stillage liquid is a bourbon stillage liquid.

26. A concrete mix, including a stillage liquid.

27. The concrete mix of item 26, wherein the stillage liquid is a processed stillage liquid.

28. The concrete mix of item 26, wherein the stillage liquid is a filtered stillage liquid without solids.

29. The concrete mix of item 26, wherein the stillage liquid has been subjected to a hydrothermal carbonization process prior to use in the mortar mix.

30. The concrete mix of any of items 26-29, wherein the stillage liquid is a bourbon stillage liquid.

31. A method of improving at least one performance characteristic of mortar, comprising adding a stillage liquid to the mortar as a substitute for at least some water in the mortar.

32. A method of improving at least one performance characteristic of concrete, comprising adding a stillage liquid to the concrete as a substitute for at least some water in the concrete.

33. A method of preparing a stillage admixture for mortar or concrete, comprising filtering solids from a stillage liquid to provide the stillage admixture.

34. A method of preparing a stillage admixture for mortar or concrete, comprising subjecting a stillage liquid to hydrothermal carbonization processing to provide the stillage admixture.

35. A method of preparing a stillage admixture for mortar or concrete, comprising filtering solids from a bourbon stillage liquid to provide the stillage admixture.

36. A method of preparing a stillage admixture for mortar or concrete, comprising subjecting a bourbon stillage liquid to hydrothermal carbonization processing to provide the stillage admixture.

37. The method of item 36, wherein the bourbon stillage liquid is subjected to a temperature of about 250° C. and a pressure of about 1.379 N/mm² during hydrothermal carbonization processing.

Each of the following terms written in singular grammatical form: “a”, “an”, and “the”, as used herein, means “at least one”, or “one or more”. Use of the phrase “One or more” herein does not alter this intended meaning of “a”, “an”, or “the”. Accordingly, the terms “a”, “an”, and “the”, as used herein, may also refer to, and encompass, a plurality of the stated entity or object, unless otherwise specifically defined or stated herein, or, unless the context clearly dictates otherwise.

Each of the following terms: “includes”, “including”, “has”, “having”, “comprises”, and “comprising”, and, their linguistic/grammatical variants, derivatives, or/and conjugates, as used herein, means “including, but not limited to”, and is to be taken as specifying the stated component(s), feature(s), characteristic(s), parameter(s), integer(s), or step(s), and does not preclude addition of one or more additional component(s), feature(s), characteristic(s), parameter(s), integer(s), step(s), or groups thereof.

The phrase “consisting of”, as used herein, is closed-ended and excludes any element, step, or ingredient not specifically mentioned. The phrase “consisting essentially of”, as used herein, is a semi-closed term indicating that an item is limited to the components specified and those that do not materially affect the basic and novel characteristic(s) of what is specified.

Terms of approximation, such as the terms about, substantially, approximately, etc., as used herein, refers to ±10% of the stated numerical value.

Although the mortar mix, the concrete mix and the related methods of this disclosure have been illustratively described and presented by way of specific exemplary embodiments, and examples thereof, it is evident that many alternatives, modifications, or/and variations, thereof, will be apparent to those skilled in the art. Accordingly, it is intended that all such alternatives, modifications, or/and variations, fall within the spirit of, and are encompassed by, the broad scope of the appended claims.

1. A mortar mix, comprising:
cement;
sand;
water; and
a stillage liquid wherein the stillage liquid has been subjected to a hydrothermal carbonization process prior to use in the mortar mix.

2. The mortar mix of claim 1, wherein the stillage liquid is a processed stillage liquid.

3. The mortar mix of claim 1, wherein the stillage liquid is a filtered stillage liquid without solids.

4. (canceled)

5. The mortar mix of claim 1, wherein the stillage liquid is a bourbon stillage liquid.

6. The mortar mix of claim 5, including:
about 23.6-24.8 weight percent cement;
about 65.0-68.3 weight percent sand;
about 6.6-9.1 weight percent water; and
about 0.3-2.3 weight percent stillage liquid.

7. The mortar mix of claim 6, wherein a ratio of a volume of the water to a volume of the stillage liquid is between about 4 to 1 and about 19 to 1.

8. The mortar mix of claim 1, including:
about 23.6-24.8 weight percent cement;
about 65.0-68.3 weight percent sand;
about 6.6-9.1 weight percent water; and
about 0.3-2.3 weight percent stillage liquid.

9. The mortar mix of claim 8, wherein a ratio of a volume of the water to a volume of the stillage liquid is between about 4 to 1 and about 19 to 1.

10. (canceled)

11. A concrete mix, comprising:
cement;
sand;
aggregate;
water; and
a stillage liquid wherein the stillage liquid has been subjected to a hydrothermal carbonization process prior to use in the mortar mix.

12. The concrete mix of claim 11, wherein the stillage liquid is a processed stillage liquid.

13. The concrete mix of claim 11, wherein the stillage liquid is a filtered stillage liquid without solids.

14. (canceled)

15. The concrete mix of claim 1, wherein the stillage liquid is a bourbon stillage liquid.

16. The concrete mix of claim 15, including:
about 13.84-19.02 weight percent cement;
about 32.57-37.05 weight percent sand;
about 39.28-44.38 weight percent aggregate;
about 4.09-6.71 weight percent water; and
about 0.34-2.41 weight percent stillage liquid.

17. The concrete mix of claim 16, wherein a ratio of a volume of the water to a volume of the stillage liquid is between about 3.3 to 1 and about 15.9 to 1.

18. The concrete mix of claim 11, including:
about 13.84-19.02 weight percent cement;
about 32.57-37.05 weight percent sand;
about 39.28-44.38 weight percent aggregate;
about 4.09-6.71 weight percent water; and
about 0.34-2.41 weight percent stillage liquid.

19. The concrete mix of claim 18, wherein a ratio of a volume of the water to a volume of the stillage liquid is between about 3.3 to 1 and about 15.9 to 1.

20. The concrete mix of claim 11, wherein a ratio of a volume of the water to a volume of the stillage liquid is between about 3.3 to 1 and about 15.9 to 1.

21. (canceled)

22. (canceled)

23. (canceled)

24. (canceled)

25. (canceled)

26. (canceled)

27. (canceled)

28. (canceled)

29. (canceled)

30. (canceled)

31. (canceled)

32. (canceled)

33. (canceled)

34. (canceled)

35. (canceled)

36. A method of preparing a stillage admixture for mortar or concrete, comprising subjecting a bourbon stillage liquid to hydrothermal carbonization processing to provide the stillage admixture.

37. The method of claim 36, wherein the bourbon stillage liquid is subjected to a temperature of about 250° C. and a pressure of about 1.379 N/mm² during hydrothermal carbonization processing.

38. The method of claim 36, further including filtering solids from a bourbon stillage liquid to provide the stillage admixture.
